(19) United States
(12) Patent Application Publication
(10) Pub. No.: US 2013/0307672 A1
(43) Pub. Date: Nov. 21, 2013

(54) SYSTEMS AND METHODS FOR MARKING SURVEYING POINTS ALONG A PROPERTY BOUNDARY

(71) Applicant: Clay Neal Reynolds, Fayetterville, TN (US)

(72) Inventor: Clay Neal Reynolds, Fayetterville, TN (US)

(21) Appl. No.: 13/854,569

(22) Filed: Apr. 1, 2013

Related U.S. Application Data
(60) Provisional application No. 61/618,997, filed on Apr. 2, 2012.

(51) Int. Cl. G01C 15/04

(52) U.S. Cl. CPC G01C 15/04
USPC 340/10.1

(57) ABSTRACT

A system for marking surveying points has a maker that is installed, e.g., buried, at a surveying point along a property boundary. Information indicative of a geographic location of the surveying point is shared in the marker. In order to later find the surveying point, a communication device is carried to the approximate location of the marker, and the communication device interrogates the marker to retrieve the stored information, which can then be used to determine the geographic location of the surveying point.

### CROSS REFERENCE TO RELATED APPLICATION

This application claims priority to U.S. Patent Application No. 61/618,997 entitled “Neal Property Locator” and filed on Apr. 2, 2012, which is incorporated herein by reference.

### BACKGROUND

At a construction site using earth-moving equipment, it is not unusual for the earth-moving equipment to accidently remove or cover surveying markers. Because the surveying markers define a property's boundary, it may be necessary to stop the use of the earth-moving equipment, at least in a given area, until a surveyor re-establishes the location of and replaces the surveying marker. Hence, the cost of the accidental removal or coverage of markers may include the fee paid to the surveyor and the downtime of the earth moving equipment and other construction delays. Although a GPS receiver is useful for providing property boundary locations, the accuracy of the GPS device is often insufficient to meet the needs of the construction project. It would be desirable to provide a system or method to avoid the costs created by accidental removal or coverage of surveying markers.

### DESCRIPTION OF THE DRAWING

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a surveying marker placed in the ground for identifying a surveying point.

FIG. 2 depicts an exemplary embodiment of a marker system of the present disclosure.

FIG. 3 is a block diagram illustrating an exemplary embodiment of a communication device, such as is depicted by FIG. 2.

FIG. 4 is a block diagram illustrating an exemplary embodiment of an electronic marker, such as is depicted by FIG. 2.

FIG. 5 is a flow chart illustrating an exemplary method for utilizing the marker system of FIG. 2.

FIG. 6 is a flow chart illustrating another exemplary method for utilizing the marker system of FIG. 2.

### DETAILED DESCRIPTION

The present disclosure describes systems for electronically marking surveying points along a property boundary. A marker of the system may be used as a replacement for or in conjunction with a conventional surveying marker. In one embodiment, a system for marking surveying points has a communication device and an electronic marker. The communication device is configured to electronically store surveying information, such as longitude and latitude coordinates of a surveying point, in memory of the electronic marker. In addition, the communication device is co figured to interrogate the electronic marker after it is buried several feet in the ground at a desired location. The information retrieved from memory in the electronic marker indicates a geographic location of a surveying point and also possibly other attributes about a property. Such information may be used by operators of earth-moving equipment that may be contouring the shape of the ground for a construction project or other users who wish to accurately mark or determine property boundaries.

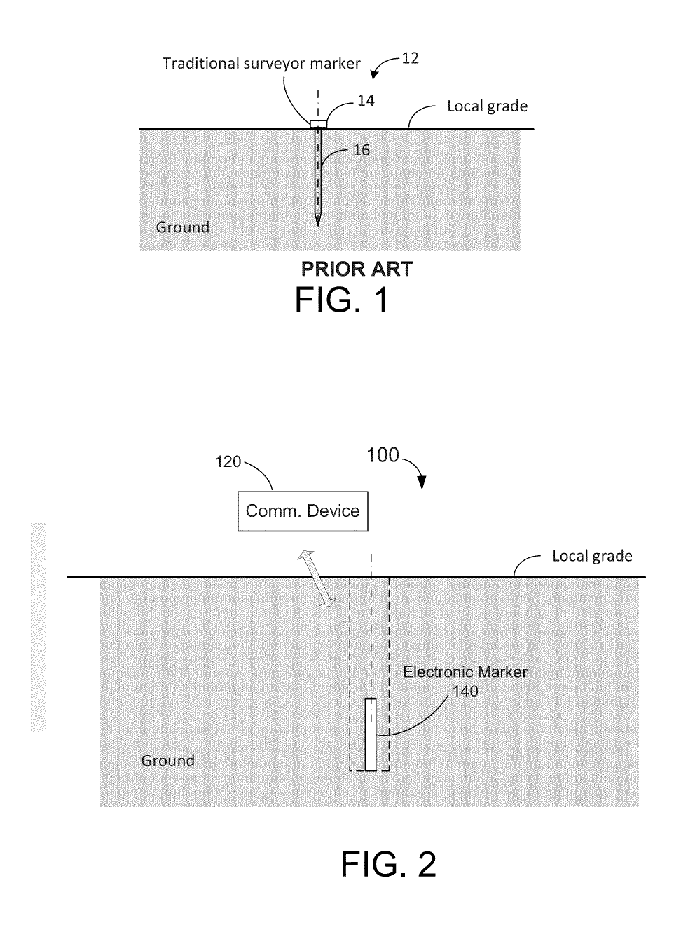

FIG. 1 depicts a conventional surveying marker 12 having a top portion 14 at local grade level and a shaft portion 16 that is in the ground. Based upon the legal description of a property, a surveyor places surveying markers at multiple location points (e.g., boundary corners) that define a property. Upon determining the location of a surveying point of a property, the surveyor drives a surveying marker 12, such as a metal stake, into the ground at that that point. For the most part, the surveying marker 12 may have information engraved or otherwise permanently placed on the head of the marker 12 so that information associated with marker 12 is available to others that may examine the property at a later time. Upon locating all the property's surveying points and driving markers 12 into the ground at such points, the surveyor has completed a survey that defines the boundaries of a property. Although the conventional marker 12 driven into the ground by the surveyor is difficult to remove, such a marker 12 may be removed accidently, such as by construction equipment, or otherwise.

An exemplary embodiment of a marker system 100 of the present disclosure is depicted in FIG. 2. The marker system 100 comprises a communication device 120 and an electronic marker 140 that is utilized to mark a surveying point. The communication device 120 is generally a portable device and may be a hand-held device, though other types of communication devices may be used in other embodiments. The electronic marker 140, having electrical components, as depicted is buried several feet below the surface of the local terrain. In one embodiment the electronic marker 140 is a passive device, i.e., it has no power source as an element, although the marker 140 may have a power source (e.g., a battery) in other embodiments. Further, the electronic marker 140 is enclosed in a container for protecting the electronic components of the marker 140 from environmental damage. In one exemplary embodiment, the container's shape has a circular cross section of approximately three inches and a length of several inches. Other shapes and/or dimensions for the container are possible in other embodiments. The electronic marker 140 may be buried in the ground between approximately one to six feet below the local grade, but other depths are possible in other embodiments.

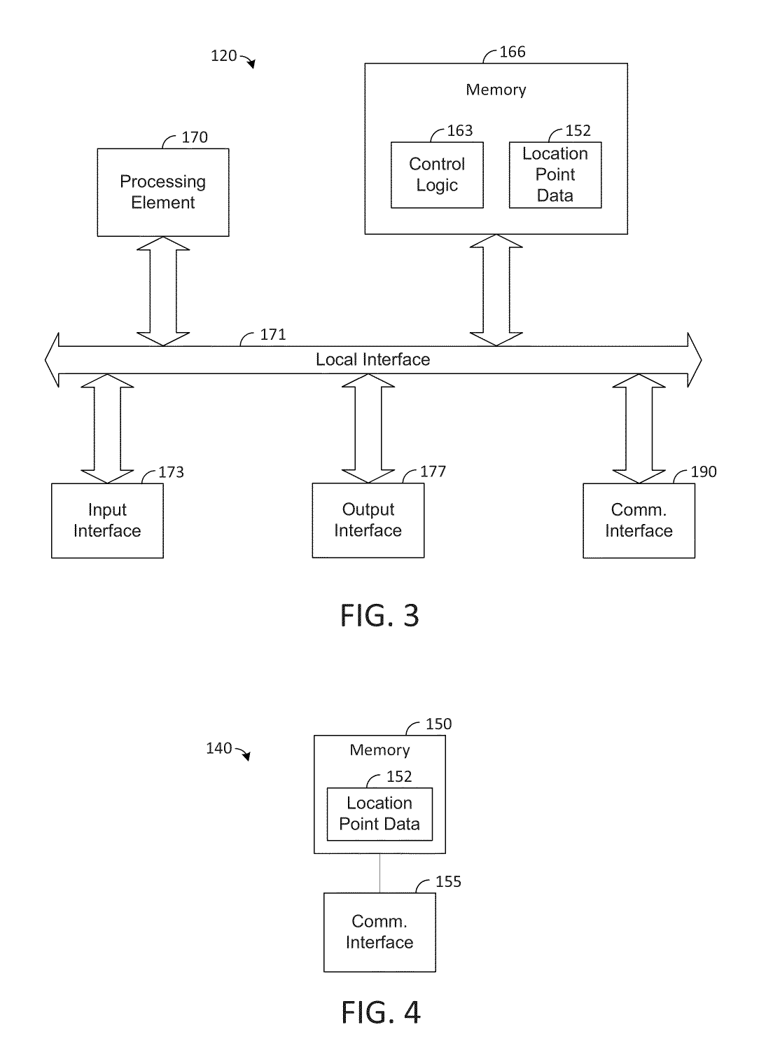

FIG. 3 depicts an exemplary embodiment of the communication device 120. As shown by FIG. 3, the communication device 120 has memory 166 for storing location point data 152, which may be downloaded into the memory 166 by the communication device 120, as will be described in more detail hereafter. The memory 166 is electrically coupled to a communication interface 190 which is configured to interact with an electromagnetic field generated by the electronic marker 140 (FIG. 4). In this regard, the communication interface 190 has an antenna (not specifically shown) and circuitry (not specifically shown) for sensing and electromagnetic field and transmitting an electromagnetic field for converting energy from such field into electrical power for powering the circuitry of the interface 155. In the presence of the electromagnetic field, the interface 155 is configured to retrieve the location point data 152 from the memory 150 and wirelessly transmit such data 152 to the communication device 120. In this regard, the interface 155 may alter or use the electromagnetic field in a manner that can be sensed by the communication device 120 in order to convey the data 152 to the device 120 in a manner similar to near field communication (NFC) and radio frequency identification (RFID) techniques. In other embodiments, other techniques (active or passive) for conveying the data 152 from the marker 140 to the communication device 120 are possible.

FIG. 4 depicts an exemplary embodiment of the electronic marker 140. As shown by FIG. 4, the electronic marker 140 comprises memory 150 and control logic 163 (such as seen in FIG. 3) for generally controlling the operation of the electronic marker 140, as will be described in more detail hereafter. The control logic 163 can be implemented in software, hardware, firmware or any combination thereof. In the exemplary electronic marker 140 illustrated by FIG. 2, the control logic 163 is implemented in software and stored in memory 150 of the electronic marker 140.

The exemplary communication device 120 depicted by FIG. 3 comprises at least one conventional processing element 170, such as a digital signal processor (DSP) or a central processing unit (CPU), that communicates to and drives the other elements within the communication device 120 via a local interface 171, which can include at least one bus. Furthermore, an input interface 173, for example, a keyboard, a keypad, or a mouse, can be used to input data from a user of the device 120, and an output interface 177, for example, a printer, monitor, liquid crystal display (LCD), or other display apparatus, can be used to output data to the user. Note that the same apparatus, such as a touchscreen, may be used to implement both the input interface 173 and the output interface 173. Further, as shown by FIG. 4, the communication device 120 comprises a communication interlace 190 that is configured to wirelessly transmit and receive data. In this regard, the interface 190 comprises an antenna (not specifically shown) and circuits (not specifically shown) for generating a radio frequency (RF) signal or electromagnetic energy of another frequency range for use in communicating between the device 120 and the marker 140, as described herein.

The communication device 120 may be implemented via a commercially available device from the 3M™ Corporation's Track and Trace Solutions Division of Austin, Tex. or from the Greenlee Corporation. Communication device 120 may be implemented via a 3M Dynatel Electronic Marker Locator and the electronic marker 140 may be from a family of markers that are configured to operate with a selected 3M Locator. Traditionally, such communication devices have been used to communicate with buried markers for underground utility infrastructure, such as utility lines and water pipes. These conventional communication devices and markers are configured with a security feature to permit different ranges for writing to and interrogating a marker. As an example, the permissible range for writing to a marker may be relatively short such that a communication device cannot reach a marker for the purposes of writing to it once the marker is buried more than a small amount, such as a few inches. However, the permissible range for interrogating and reading from the marker may be longer (e.g., several feet) such that a buried marker may be interrogated by a communication device that is above ground. Such a security feature helps to protect unauthorized changes to the data in the marker once it is buried.

When the communication device 120 is in a transfer mode, a user provides inputs via the input interface 173 or otherwise for defining the location point data 152, which is indicative of various attributes about the property and/or the property boundary on which the marker 140 is located. Specifically, the location point data 152 indicates at least the geographic location of a surveying point along the property boundary. As an example, the location point data 152 may indicate a property owner's name, a name of the surveyor, a deed book number and page, the geographic coordinates of a surveying point, a date the electronic marker was installed, and/or other desired information.

When instructed by the user, the control logic 163 is configured to retrieve the location point data 152 from the memory 166, and to cause the communication interlace 190 to wirelessly transmit such data 152 to the marker 140 for storage in the marker 140. As will be described in more detail below, if it is desirable to later discover the boundary point indicated by the data 152, such as for installing a surveying marker 12 or otherwise, the data 152 may be retrieved from the electronic marker 140 by the device 120 or otherwise in order to determine the geographic location of the boundary point without having to perform another survey.

In this regard, the communication device 120 has an interrogation mode wherein a request is wirelessly transmitted to the electronic marker 140 from the device 120. The request from the communication device 120 activates the electronic marker 140, which uses the electromagnetic energy from the request to power the components of the marker 140 in order to provide property location information to the user. Specifically, ire one exemplary embodiment, the communication device 120 generates an RF signal that is converted into power by the electronic marker 140. The converted power is sufficient to allow the electronic marker 140 to return, i.e. wirelessly transmit, the location point data 152 to the communication device 120. The data 152 received by the communication device 120 may be displayed via the output interface 177 or otherwise for review by a user.

In some embodiments a conventional surveying marker 12 may be placed directly about a buried electronic marker 140 thereby having two r Barkers indicating the location of a surveying point. Such an arrangement allows those without a communication device 120 to locate a surveying point. However, if the conventional marker 12 is missing, because of accidental removal or other reasons, the surveying point may be identified via wireless interrogation of the electronic marker 140. Once the surveying point has been relocated, a conventional surveying marker 12 may be placed at the surveying point or other action may be taken as desired.

As an example, assume that a conventional surveying marker 12 marks the same boundary point as electronic marker 140, and assume that the marker 12 is accidentally moved such that it no longer marks the boundary point. In such case, the location point data 152 in the electronic marker 140 may be used to find the boundary point so that the conventional marker 12 can be re-installed at the correct point without having to perform another survey.

It should be noted that it is unnecessary for the location point data 152 to be wirelessly communicated the marker 140. As an example, it is possible to store the data 152 in the marker 140 before burying it or for the marker 140 to be coupled to a communication medium (e.g., a conductive wire) that can be used to transfer data 152 to and/or from the marker 140.

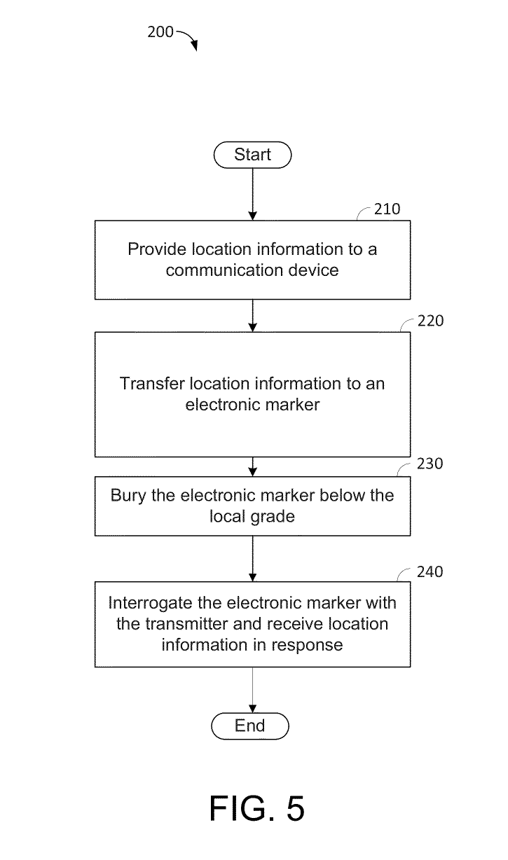

An exemplary operation and use of the system 100 will now be described below with reference to FIG. 5.

After a surveying point is located, via a traditional surveying process, the surveying point is then marked with an electronic maker 140. In this regard, a user inputs via input interface 173 of the communication device 120 location point data 152 indicative of a geographic location of the surveying point, block 210. Once the location information is provided to the communication device 120, the electronic marker 140 is placed near the antenna of the communication interface 190. The communication device 120 then wirelessly transmits information to the electronic marker 140 via such antenna, block 220.

In one embodiment, the communication device 120 and the electronic marker 140 of the marker system 100 are configured so that the communication device 120 may write location point data 152 to the marker 140 only when it is within around six inches of the marker 140. Hence, when the electronic marker 140 is buried around one foot or more in the ground, the location information cannot be changed by anyone, such as an unauthorized person, using a device similar to the communication device 120. Upon completion of the transfer of the surveying point information to the electronic marker 140, the electronic marker 140 is buried, block 230. While the electronic marker 140 remains buried, the location point data 152 stored in the marker 140 cannot be easily changed due to the security feature described above, but the location point data 152 can be retrieved when the communication device 120 is in the interrogation mode, block 240.

In this regard, assume that a conventional marker 12 is installed above the electronic marker 140 such that a top portion 14 of the marker 12 is above ground level, as shown by FIG. 1. Further, assume that the marker 14 is accidentally displaced such that it no longer accurately marks the location of the surveying point. In order to find the surveying point, a user places the communication device 120 into the interrogation mode via user input so that the communication device 120 continuously emits a wireless signal for interrogating the marker 140. The user also carries the communication device 120 within the vicinity of where he or she believes the surveying point to be. When the communication device 120 is positioned close enough to the marker 140 to enable communication, the wireless signal emitted by the communication device 120 automatically activates the marker 140, which then retrieves the location point data 152 and wirelessly transmits this data 152 to the communication device 120. As indicated above, such data 152 indicates the geographic location (e.g., latitude and longitude coordinates) of the surveying point. The communication device 120 displays the data 152 to the user who can then use this information to find the surveying point without performing a new survey.

In addition, in one embodiment, the communication range between the device 120 and the marker 140 is relatively short such that the communication device 120 is close to the surveying point when communication is enabled. In such an embodiment, the user is aware that the location of the communication device 120 is close to the surveying point when communication is established with the marker 140. Thus, the knowledge of the position of the communication device 120 at the time of establishing communication with the marker 140 is useful for finding the surveying point.

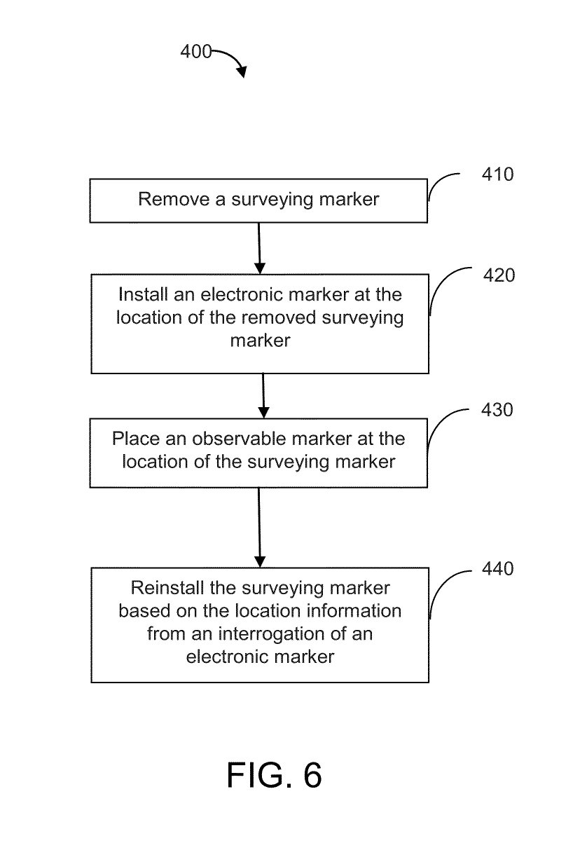

An exemplary operation and use of the system 100 will now be described below with reference to FIG. 6.

For illustrative purposes, assume that a conventional marker 12 is installed at a surveying point, as shown by FIG. 1. Also assume that it is desirable to perform earth-moving operations, such as bulldozing, in the vicinity of the marker 12. In such case, it may be desirable to install an electronic marker 140 for the surveying point so that this point can be located in the event that the earth moving operations inadvertently displace the conventional marker 12.

Initially, before the earth-moving earth operations begin, a user removes the installed surveying marker 12, block 310. After the surveying marker 12 is removed, an electronic marker 140 is installed at the location of the removed surveying marker 12, block 320. To install the electronic marker 140, a user digs a hole in the ground, thereby providing a vertical cavity defined by surfaces of the earth that are below the local grade. The hole is generally several feet deep and has a shape and dimensions to permit insertion of the electronic marker 140 into the hole. In one embodiment, the electronic marker 140 is around two to four inches in diameter and is about 5 inches long, though other dimensions are possible in other embodiments. Once the electronic marker 140 is placed into and rests near the bottom of the hole, the electronic marker 140 is covered with material, such as earth, sand, or other suitable materials. Once the electronic marker 140 has been installed, a user may place one or more temporary markers, such as driving stakes into the ground, for providing the earth-moving equipment operator with visual reference points. Upon completion of the new contour of the land, the previously-removed surveying marker 12 is reinstalled based on surveying point information provided by interrogation of the electronic marker 140 by the communication device 120, as described above.

It would be understood by those skilled in the art that system 100 may use RFID technology or other known technology to provide the functions of communication device 120 and electronic marker 140. The exemplary embodiments provided may be changed and modified without departing from the spirit and scope of the disclosure.

Now, therefore, the following is claimed:

1. A system for marking surveying points, comprising:
a communication device; and
a marker having memory for storing location point data indicative of a geographic location of a surveying point along a property boundary, the marker positioned underground at the surveying point, wherein the marker is configured to wirelessly transmit the location point data to the communication device.

2. The system of claim 1, wherein the marker is passive and uses power from a wireless signal transmitted by the communication device for transmitting the location point data to the communication device.

3. The system of claim 1, wherein the communication device is configured to interrogate the marker thereby causing the marker to retrieve the location point data and convey the location point data to the communication device.

4. The system of claim 1, wherein the location point data indicates geographic coordinates of the surveying point.

5. A method for marking surveying points, comprising:
storing location point data in memory of a marker, the location point data indicating a geographic location of a surveying point along a property boundary;
burying the marker; and
wirelessly transmitting the location point data from the marker to a communication device while the marker is buried.

6. The method of claim 5, wherein the marker is buried at the surveying point.

7. The method of claim 5, further comprising displaying the location point data via the communication device.

8. The method of claim 5, further comprising installing a marker at the location point based on the location point data,

7. The method of claim 5, further comprising interrogating the marker with a wireless signal from the communication device, wherein the wirelessly transmitting is responsive to the interrogating.

8. The method of claim 7, further comprising powering the marker based on the wireless signal.

9. A method for marking surveying points, comprising:
storing location point data in memory of a marker, the location point data indicating a geographic location of a surveying point along a property boundary;
installing the marker at the surveying point;
transmitting the location point data from the marker to a communication device; and
locating the surveying point based on the transmitted location point data.

10. The method of claim 9, wherein the installing comprises burying the marker at the surveying point.

11. The method of claim 9, further comprising displaying the location point data via the communication device.

12. The method of claim 9, further comprising installing a marker at the location point based on the location point data,

13. The method of claim 9, further comprising interrogating the marker with a wireless signal from the communication device, wherein the transmitting is responsive to the interrogating.

14. The method of claim 13, further comprising powering the marker based on the wireless signal.
